(19) United States
(12) Patent Application Publication
(10) Pub. No.: US 2004/0173439 A1
(43) Pub. Date: Sep. 9, 2004

(54) Flexible screw feeder/mixer for precision dosing and feeding of particulate systems

(76) Inventors: Ali Ismail Abdel-Hadi, Gainesville, FL (US); Nicolaie D. Cristescu, Gainesville, FL (US)

Correspondence Address: MILES & STOCKBRIDGE PC, 1751 PINNACLE DRIVE, SUITE 500, MCLEAN, VA, 22102-3833, US

(21) Appl. No.: 10/626,872

(22) Filed: Jul. 25, 2003

Related U.S. Application Data
(60) Provisional application No. 60/398,108, filed on Jul. 25, 2002.

(51) Int. Cl. B65G 33/26

(52) U.S. Cl. 198/659

(57) ABSTRACT

Disclosed is a flexible screw feeder for conveying and/or mixing particulate solids comprising a hollow feed tube in which the particulate solid is transported from a first location to a second location; and auger conveying means within the feed tube comprising a shaft carrying a plurality of flexible elements helically arrayed to form a spiral.

### BACKGROUND OF THE INVENTION

1. Field of the Invention

The invention relates to a novel mechanical screw feeder particularly adapted for the conveyance of finely divided particulate solids.

2. Description of the Prior Art

It is often necessary to convey finely divided particulates such as fine chemicals, powders and pharmaceuticals through tubular conduits for the purpose of mixing or dosing them to another system. The utilization of conventional mechanical screw feeders often disadvantageously results in heating of the particulates due to the compaction forces exerted thereupon by the rigid screw. This heating often results in unwanted degradation of the physical and/or chemical properties of the particulate material. In addition, conventional rigid screw feeders may also result in unwanted agglomeration or lumping of the particulates as well as a reduction of the particle sizes of the particulates because of the physical forces exerted thereon.

In addition, conventional conveying systems such as belt, rigid screw and vibrating conveyors, bucket elevators and Redler conveyors are simply not suitable for handling small amounts of very finely divided particulate material.

### SUMMARY OF THE INVENTION

The present invention provides a novel flexible mechanical screw feeder that avoids the above-noted disadvantages associated with conventional rigid screw feeders when employed to convey or admix finely divided particulate solids.

One embodiment of the invention relates to a flexible screw feeder for conveying and/or mixing particulate solids comprising a hollow feed tube in which the particulate solids are transported from a first location to a second location; and auger conveying means within the feed tube comprising a shaft carrying a plurality of flexible elements helically arrayed to form a spiral. The conveying means may also include means for rotating the auger conveying means such that the particles of the solid are conveyed by the flexible elements from the first location to the second location.

A further embodiment of the invention concerns an article of manufacture comprising means for conveying and/or mixing particulate solids, wherein the conveying means is effective for the conveyance of particulate solids preferably having a particle size less than about 400 microns, and wherein the article includes instructions for using the conveying means for conveying a particulate solid, wherein the conveying means is that described above.

A still further embodiment of the invention relates to methods for delivering particulate solids from a first location to a second location or mixing particulate solids, the method comprising transporting the particulate solids through a feeder tube positioned between the locations by rotating an auger conveying means positioned in the feeder tube, the auger conveying means having a helical flight of flexible elements, the rotational motion of the auger conveying means causing the flexible elements to carry the particulate solids between the locations and to admix them; the flexibility of the flexible elements preventing any substantial agglomeration, or degradation of the chemical or physical properties or particle sizes of the particulate solid.

An additional embodiment of the invention comprises a means for determining the dispersibility and/or flowability distribution of a particulate solid comprising the above described conveying means and means for measuring the flow rate of the particulate solid through the feeder tube.

A further embodiment of the invention relates to a method for determining the dispersibility and/or flowability distribution of a particulate solid comprising transporting the particulate solid through a feeder tube positioned between two locations by rotating an auger conveying means positioned in the feeder tube, the auger conveying means having a helical flight of flexible elements, the rotational motion of the auger conveying means causing the flexible elements to carry the particulate solid between the locations and measuring the flow rate of the particulate solid through the feeder tube.

Other objects, features and advantages of the present invention will become apparent to those skilled in the art from the following detailed description. It should be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

FIG. 1 shows a flexible screw feeder/mixer of the invention.

FIG. 2 depicts different flow rates for two grades of microcrystalline cellulose in the screw feeder of the invention.

FIG. 3 depicts mass flow rate for alumina conveyed in the feeder of the invention.

### DETAILED DESCRIPTION OF THE INVENTION

The rotating helical screw of the feeder of the invention comprises, for example, flexible bristles that are tightly packed and firmly fixed onto the core shaft. During rotation of the bristles along the inner core of the feeder, the particulates are swept along in an intermittent fashion thereby resulting in a gentle handling of the particles. Moreover, the flexibility of the screw elements renders the feeder adaptive to the feed material in that they will conform their selves to the particles as they are presented thereto. This gentle, adaptive, intermittent action results in far less compaction, agglomeration, lumping, degradation (both physical and chemical), pulverization, mechanical damage and heating of the particulate feed material than conventional screw feeders.

In addition, the zero clearance existing between the tightly fitting helix of the screw and the inner wall of the feeder shaft results in the screw feeder of the invention being self-cleaning while the system is in use.

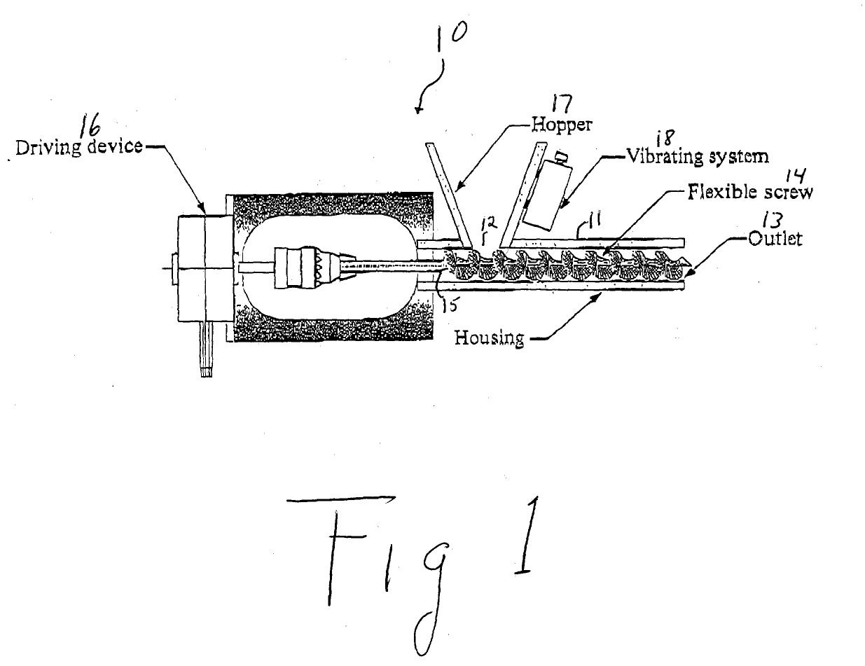

Referring to FIG. 1, the screw feeder 10 of the invention essentially comprises feed tube 11 for conveying the particulate solid (not shown) from a first location 12 to a second location 13, here, the outlet of feeder tube 11 and auger (screw) conveying means 14 positioned within the feed tube 11 and comprising a shaft 15 carrying a plurality of flexible elements helically arrayed to form a spiral. Attached to shaft 15 is a driving device 16 for rotating the screw conveying means 14. The driving device 16 may also be equipped with means (not shown) for controlling the rate of rotation of the shaft 15. Hopper 17 containing the particulate solid is preferably positioned so that it can meter the particulate solid into the feed tube 11 at first location 12. The hopper may communicate directly with the feed tube as shown or may indirectly meter particulate solid through a tube or other device (not shown). A vibrator 18 may be attached to the hopper 17 for facilitating metering of particulate solid into the feed tube 11. In operation, the particulate material is loaded into hopper 17 and is fed into the feeder tube 11 at first location 12 by the action of the vibrator 18 acting on the walls of the hopper 17. The rotating flexible screw 14, driven by device 16 feeds the particulate material through the housing feeder tube 11 to the second location (outlet 13) where it is discharged as desired.

The spiral of the flexible screw has a diameter slightly greater than the inside diameter of the feed tube. The flexible elements are sufficiently flexible to bend without permanently deforming or breaking during rotation within the feeder tube but sufficiently rigid to convey the particulate solid through the feeder tube without substantial agglomeration, or degradation of the chemical or physical properties or particle sizes thereof. The flexibility of the screw results in an intermittent action thereof which works to reduce or eliminate segregation and agglomeration of the particulate material. The gentle sweeping action of the screw works to prevent consolidation of fine particles of the feed material. The flexible elements may take any desired form, e.g., bristles, filaments, hair, fibers, etc., and may be constructed of any suitable material that does not deleteriously impact on the operation of the device or affect the chemical or physical properties or particle sizes of the particulate solid transported therein. Suitable materials of construction include polymers such as nylon, graphite, polyethylene, polyurethanes, polyesters, etc.

Often, in transporting small particles the electrostatic buildup that is generated by the friction between the particles and the walls of the feeder tube can hinder the uniform flow of particles in the feeder. To overcome this difficulty, it is preferred to construct the bristles of the helical screw from an electrically conductive material. Thus, eliminating any potential problem from electrostatic buildup. The entire assembly can be grounded, thus preventing any potential problem from electrostatic charges.

Although the feed tube is depicted and exemplified herein as cylindrical it will be understood by those skilled in the art that it may take any desired geometrical form provided that the flexible screw is also designed such that the flexible elements thereof contact all interior surfaces thereof. Moreover, although the feeder tube is oriented horizontally and the hopper is positioned such that the axis thereof is perpendicular to the axis of the feeder tube in the drawings, it will be understood by those skilled in the art that these elements may also bear any desired geometrical relationship, provided that it does not interfere with conveyance of the particulate solid.

The apparatus of the invention is ideally suited for the handling and conveyance of finely divided, powdered material such as pharmaceuticals, the nanoscale transport of nano particles and the like. The system can be employed as a dosing device, for the filling of rheometers, for depositing particles on viewing surfaces for microscopy, digital image analysis and the determination of particle size distribution and as. a diagnostic tool to measure the dispersibility and/or flowability of fine powders.

The system of the invention is also susceptible to construction from inexpensive materials and components, e.g., aluminum, brass, steel, nylon, bristles of various kind, inexpensive stepper motors, tubes, etc., such that it is disposable; i.e., it could be destroyed or discarded after use thereby making it ideal for handling of toxic particulate material where cleaning would be a high risk proposition.

FIG. 2 depicts different flow rates in the system of the invention shown in FIG. 1 for two grades of microcrystalline cellulose (MCC) PH1O1(50 μm) and PHIO2(90 μm) using the same screw rotational speed, with the vibrating system. The results show that particle size distribution for the same material produces different flow rates. Thus, the device of the invention can be used as a simple diagnostic tool for measuring the dispersibility and/or flowability of a particulate material. The flow rate can be measured accurately by simply attaching the entire assembly to a platform (e.g., beam with a sensor) that acts as a scale. The scale can be calibrated by suitable means so that the output of the scale can be converted to mass by using a calibration factor. Subsequent readings of the mass divided by the time interval between those readings will give the mass flow rate.

FIG. 3 depicts mass flow rate for alumina (100 μm) using the same rotational speed as that of microcrystalline cellulose above. It can be observed from the curve that the flow is very uniform.

1. Means for conveying and/or mixing a particulate solid comprising:
a hollow feed tube in which said particulate solids are transported from a first location to a second location; and
auger conveying means within said feed tube comprising a shaft carrying a plurality of flexible elements helically arrayed to form a spiral.

2. A disposable conveying means of claim 1.

3. The conveying means of claim 1 including means for rotating said auger conveying means such that the particles of said solid are conveyed by said flexible elements from said first location to said second location.

4. The conveying means of claim 1 wherein said spiral has a diameter greater than the inside diameter of the feed tube.

5. The conveying means of claim 1 wherein said feed tube is cylindrical.

6. The conveying means of claim 5 wherein said feed tube is positioned substantially horizontally.

7. The conveying means of claim 1 wherein said first location includes a container for holding a supply of said particulate solids.

8. The conveying means of claim 7 wherein said container is a hopper coupled to said feed tube by means for metering said particulate solids into said feed tube.

9. The conveying means of claim 8 wherein coupling means is a tube extending from an outlet of said hopper into said feeder tube.

10. The conveying means of claim 8 wherein the axis of the hopper is perpendicular to the axis of the feed tube.

11. The conveying means of claim 8 also including means for vibrating said hopper to facilitate the metering of said particulate solids into said feed tube.

12. The conveying means of claim 1 wherein said flexible elements are sufficiently flexible to bend without permanently deforming or breaking during rotation within said feeder tube but sufficiently rigid to convey said particulate solids through said feeder tube without substantial agglomeration, or degradation of the chemical or physical properties or particle sizes thereof.

13. The conveying means of claim 12 wherein said flexible means are adapted to convey a particulate solid having a particle size of less than about 400 microns.

14. The conveying means of claim 1 wherein said flexible elements are bristles.

15. The conveying means of claim 1 wherein said second location is an outlet from said feeder tube.

16. The conveying means of claim 3 including means for controlling the rate of auger conveyor rotation.

17. An article of manufacture comprising means for conveying and/or mixing particulate solids, wherein said conveying means is effective for the conveyance of particulate solids, and wherein said article includes instructions for using said conveying means for conveying and/or mixing particulate solids, and wherein said conveying means is that of claim 1.

18. The article of manufacture of claim 17 wherein said particulate solid is a pharmaceutical composition.

19. The article of manufacture of claim 17 wherein said particulate solid is microcrystalline cellulose.

20. A method of delivering particulate solids from a first location to a second location or admixing said solids, the method comprising transporting said particulate solids through a feeder tube positioned between said locations by rotating an auger conveying means positioned in said feeder tube, said auger conveying means having a helical flight of flexible elements, the rotational motion of the auger conveying means causing the flexible elements to carry the particulate solids between said locations; the flexibility of said flexible elements preventing any substantial agglomeration, or degradation of the chemical or physical properties or particle sizes of said particulate solids.

21. The method of claim 20 including controlling the rate of auger conveyor rotation.

22. In a method of delivering particulate solids from a first location to a second location or admixing said solids, the method comprising transporting said particulate solids through a feeder tube positioned between said locations by rotating an auger conveying means positioned in said feeder tube, said auger conveying means having a helical flight of flexible elements, the rotational motion of the auger conveying means causing the flexible elements to carry the particulate solids between said locations; the flexibility of said flexible elements preventing any substantial agglomeration, or degradation of the chemical or physical properties or particle sizes of said particulate solids, the improvement comprising disposing of said feeding tube and auger conveying means following said delivering or admixing.

23. A means for determining the dispersibility and/or flowability distribution of particulate solids comprising the means of claim 1 and means for measuring the flow rate of said particulate solids through said feeder tube.

24. A method for determining the dispersibility and/or flowability distribution of particulate solids comprising transporting said particulate solids through a feeder tube positioned between two locations by rotating an auger conveying means positioned in said feeder tube, said auger conveying means having a helical flight of flexible elements, the rotational motion of the auger conveying means causing the flexible elements to carry the particulate solids between said locations and measuring the flow rate of said particulate solids through said feeder tube.

25. A means according to claim 1 wherein said flexible elements are constructed of an electrically conductive material and said means is electrically grounded to avoid electrostatic build-up in said particles.
